(19) United States
(12) Patent Application Publication
(10) Pub. No.: US 2014/0358570 A1
(43) Pub. Date: Dec. 4, 2014

(54) HEALTHCARE SUPPORT SYSTEM AND METHOD

(71) Applicant: KONINKLIJKE PHILIPS N.V., Eindhoven (NL)

(72) Inventors: ALEKSANDRA TESANOVIC, EINDHOVEN (NL); JAN JOHANNES GERARDUS DE VRIES, EINDHOVEN (NL); GIJS GELEIJNSE, GELDROP (NL)

(21) Appl. No.: 13/909,779

(22) Filed: Jun. 4, 2013

(51) Int. Cl. G06F 19/00

(52) U.S. Cl. CPC G06F 19/345
USPC 705/2

(57) ABSTRACT

A healthcare support system for determining care for a patient and a corresponding healthcare support method are presented. The healthcare support system comprises a processor and a computer-readable storage medium, wherein the computer-readable storage medium contains instructions for execution by the processor, wherein the instructions cause the processor to perform the steps of obtaining patient data, assessing a clinical need of the patient, proposing a clinical outcome, and determining a service to be provided to the patient for said clinical need and said proposed clinical outcome based on a service-outcome-need model. Further, the present invention relates to a computer-readable non-transitory storage medium and a computer program.

### FIELD OF THE INVENTION

The present invention relates to a healthcare support system for determining care for a patient comprising a processor and a computer-readable storage medium, wherein the computer-readable storage medium contains instructions for execution by the processor. Further, the present invention relates to a corresponding healthcare support method, a computer-readable non-transitory storage medium and a computer program.

### BACKGROUND OF THE INVENTION

Clinical decisions support (CDS) systems have become a leading response to the growing demand for the promotion of standards-based care delivery. CDS tools are important components of clinical information technology (IT) systems and may directly improve patient care outcomes and the performance of healthcare organizations.

A patient with a chronic condition is normally managed across care settings. The patient starts his journey at the hospital ward, is discharged home and continues care at home with supervision of an out-patient clinic or a general practitioner.

US 2010/0082369 A1 discloses a system and method for interconnected personalized digital health services. As a part of their digital services, US 2010/0082369 A1 further discloses that it would be desirable to generate a personalized care plan for a patient based on health information from a database. The care plan should be generated by applying some form of tools. However, a solution to this problem is not presented in detail.

As a solution, US 2007/0244724 A1 discloses the use of a historic reference database for identifying patient records that closely correspond to the patient being treated. A physician is presented with an outcome history and a treatment history of historic patients that can serve as indicators for a likely outcome and proposed course of treatment for the present patient.

However, the way of determining care for a patient can be further improved. The solution disclosed in US 2007/0244724 A1 is limited to recommendations that have been applied to a historic patient population. Such a system would be limited to repeating past recommendations but does not foster the progress of new treatments or the use of an existing treatment in a new context.

### SUMMARY OF THE INVENTION

It is an object of the present invention to provide a healthcare support system and healthcare support method that better assist in determining the right service to be provided to the patient. It is a further object of the present invention to improve care across different care settings.

In a first aspect of the present disclosure, a healthcare support system for determining care for a patient is presented that comprises a processor and a computer-readable storage medium, wherein the computer-readable storage medium contains instructions for execution by the processor, wherein the instructions cause the processor to perform the steps of:
obtaining patient data,
assessing a clinical need of the patient,
proposing a clinical outcome, and
determining a service to be provided to the patient for said clinical need and said proposed clinical outcome based on a service-outcome-need model.

In a further aspect of the present disclosure a corresponding healthcare support method is presented.

In yet other aspects of the present disclosure, there are provided a computer program which comprises program code means for causing a computer to perform the steps of the healthcare support method when said computer program is carried out on a computer, and a computer-readable non-transitory storage medium containing instructions for execution by a processor, wherein the instructions cause the processor to perform the steps of the claimed healthcare support method.

Preferred embodiments of the disclosure are defined in the dependent claims. It shall be understood that the claimed method, computer program, and computer-readable non-transitory storage medium have similar and/or identical preferred embodiments as the claimed system and as defined in the dependent claims.

Compared to known systems and methods, the system and method according to the present invention improves the determination of a service to be provided to the patient. To optimize the care and to improve clinical outcomes, the inventors have found that appropriate services not only have to be provided at the hospital, but also need to be put in deteriorations at an early stage and/or to empower the patient's self-care abilities.

Today, such services are assigned to the patient ad-hoc, are exclusive for one care setting, or are not able to adapt as the patient condition changes over time. For example, a home health agency assigns certain services to the patient. These services, however, might not necessarily be recommended or endorsed by the primary care setting, for example a treating physician at the hospital.

Compared to known systems and methods, the present disclosure not only provides a service that addresses the current need of the patient but also takes a proposed clinical outcome into account. Thereby, the determined services can be calibrated across care settings and through the natural progression of patients' condition and co-morbidities to ensure the best care for a particular patient.

In one aspect, the invention provides for a healthcare support system. A healthcare support system as used herein encompasses an automated system for determining a service to be provided to the patient for a clinical need and a proposed clinical outcome. The healthcare support system comprises a processor and a computer-readable storage medium.

A ‘computer-readable storage medium’ as used herein encompasses any storage medium which may store instructions which are executable by a processor of a computing device. The computer-readable storage medium may be referred to as a computer-readable non-transitory storage medium. The computer-readable storage medium may also be referred to as a tangible computer-readable medium. In some embodiments, a computer-readable storage medium may also be able to store data which is able to be accessed by the processor of the computing device. Examples of a computer-readable storage medium include, but are not limited to: A floppy disk, a magnetic hard disk drive, a solid state hard disk, flash memory, a USB thumb drive, Random Access Memory (RAM), Read Only Memory (ROM), an optical disk, a magneto-optical disk, and a register file of the processor. Examples of optical disks include Compact Disks (CD) and Digital Versatile Disks (DVD), for example CD-ROM, CD-RW, CD-R, DVD-ROM, DVD-RW, or DVD-R disks as well as Blue Ray Disks (BD). The term computer-readable storage medium also refers to various types of recording media capable of being accessed by the computer device via a network or communication link. For example, data may be retrieved over a modem, over the internet or over a local area network.

A ‘processor’ as used herein encompasses an electronic component which is able to execute a program or machine executable instruction. References to the computing device comprising ‘a processor’ should be interpreted as possibly containing more than one processor. The term computing device should also be interpreted to possibly refer to a collection or network of computing devices each comprising a processor. Many programs have their instructions performed by multiple processors that may be within the same computing device or which may even be distributed across multiple computing devices.

The term ‘clinical need’ as used herein encompasses a need following from a disease, symptom, and/or mental or physical status that affects the patient's current and/or future health or well-being. The term ‘outcome’ or ‘clinical outcome’ relates to an expected mental and/or physical status of the patient after an intervention such as providing a service to the patient. The decision to do nothing or not to change an existing treatment can also be seen as an intervention with an corresponding outcome. Thereby, the outcome also covers whether the patient requires a medical facility or can be taken care of at home. Thus the clinical outcome also comprises the results readmission or self-care. A ‘service’ encompasses any measure provided to the patient for treatment of a medical condition in particular for addressing a clinical need.

In a preferred embodiment the service-outcome-need model provides a relationship between a service provided to the patient, a clinical outcome and a clinical need of the patient. Thus, the determination or recommendation of a service to be provided to the patient not only depends on the current patient status and current clinical need of the patient, but also takes into account a proposed clinical outcome. Thereby, not only the circumstances of the current care setting, for example a hospital, are taken into account but also the circumstances of a target care setting for example, care by an out-patient clinic or self-care at home, are taken into account when determining the service to be provided. This ensures, that not only services are offered that are exclusive for one care setting. Thereby, services can be recommended that are recommended or at least endorsed by different care settings that are relevant for the patient. This is particularly important for a patient with a chronic condition who is normally managed across care settings. For example there are several options for a service to be provided but only one of them is supported by a hospital ward, a home case care under supervision. Hence, this supported service is assigned to the patient. In other words, an aspect of the present invention relates to a system that determines care for a patient with a chronic condition and aligns or calibrates care across different care settings.

In an embodiment, the service-outcome-need model further comprises an ontology, which ontology gives a relationship of clinical needs for a clinical domain or a disease. An ontology is a source of structured knowledge that allows a computer to reason about that knowledge. For example, from a (dedicated medical) ontology it can be derived that there is a relation between a particular service and (clinical) outcome, which enables a computer system to suggest the application of the service if the outcome is of importance to a patient. Alternatively, an ontology provides relations between clinical needs for example provides structured information about which clinical needs depend upon each other in form of a mathematical graph. For example an ontology based on the ICD-10 system allows drawing automated conclusions such as ‘heart failure’ is a ‘cardiac condition’. As a further example, SNOMED is a standardized knowledge source where medical conditions and their relations are defined. Extensions to such a knowledge source, for example extensions that fit local needs, conditions or situations, can easily be made. For example, it may be used to derive that a cardiac echo may give insights into the patient's left ventricular ejection fraction.

In an advantageous embodiment the healthcare support system further comprises a service database, wherein for each service there is an instance of the service-outcome-need model.

Preferably, the instructions further cause the processor to perform the step of creating said service database based on patient data. Patient data can be obtained from various sources, such as an electronic health record (EHR) which can be part of a hospital information system (HIS). The patient data of a large patient population can serve as an input.

In an advantageous embodiment the creation of said service database further comprises obtaining data from clinical studies and/or clinical expert. Data from clinical studies can be particularly relevant, because of the typically well-controlled boundary conditions of a clinical study. Thus, the service database is advantageously enriched by further sources. Optionally, this includes the mining of medical journals. Thus, the system and method according to the present invention are broader than conventional solutions in the sense that additional knowledge sources, such as ontologies, or knowledge mined from medical journals can be used. This allows the recommendation of a service for a specific patient or patient group for which the service was not or only infrequently applied before. Thereby, the proposed method and system provide recommendations that are different from the traditional way of working in the hospital.

In another embodiment, the instructions further cause the processor to perform the step of updating said service database based on the obtained data. This can be seen as a feedback mechanism for providing input on the effectiveness of a proposed service for a particular patient. Thereby, proposed services could change based on the received feedback.

In an advantageous embodiment, the healthcare support system is a self-adapting system. Thus, the system may continuously determine the most appropriate service to be provided to the patient to improve the specific clinical need of this particular patient. These adjustments may be computed each time when the patient's health status is changed, for example after a hospitalization or an out-patient clinic visit or during home monitoring using these services.

In a further embodiment, the service to be provided to the patient is determined when new patient data is obtained and/or when the service-outcome-need model is updated. For example, feedback from a different patient or different set of patient provides input on the effectiveness of a proposed service. In response, the proposed services for a particular group of patients can be changed.

In a further embodiment, the service-outcome-need model comprises patient classes. A class can be based on historic patient data and can be for example created using either machine learning techniques only or with input and/or validation by a clinical expert. As an advantage, the use of patient classes simplifies data processing.

In conclusion, the determination of services provided to a patient is improved and, in particular, takes the outcome and different care settings into account.

### BRIEF DESCRIPTION OF THE DRAWINGS

These and other aspects of the invention will be apparent from and elucidated with reference to the embodiments described hereinafter. In the following drawings

FIG. 1 illustrates the journey of a patient through different care settings;

FIG. 2 shows a schematic diagram of a first embodiment of the proposed healthcare support system;

FIG. 3 shows a flow chart of a first embodiment of the proposed healthcare support method;

FIG. 4A shows a representation of the service-outcome-need model;

FIG. 4B shows a first instantiation of the service-outcome-need model;

FIG. 4C shows a second instantiation of the service-outcome-need model;

FIG. 5 illustrates the creation of a services database;

FIG. 6 shows the creation of a clinical-needs ontology;

FIG. 7 shows an example of a clinical needs ontology;

FIG. 8 shows a flow chart an example of a process for determining a service to be provided to the patient;

FIG. 9 shows examples of services to be provided to the patient;

FIG. 10 shows a flow chart of a further example of a process for determining a service to be provided to the patient.

### DETAILED DESCRIPTION OF THE INVENTION

A patient, in particular a patient with a chronic condition, is normally managed across care settings. FIG. 1 illustrates an exemplary journey of a patient through different care settings. In this example, the patient starts his journey at the hospital and is then discharged home under the supervision of an out-patient clinic that takes care of the rehabilitation process. After rehabilitation, the patient takes care of himself at home. Optional additional services, such as telehealth monitoring can be applied at home. Once the patient's condition has deteriorated the patient may consults a general practitioner, who may then decide to send the patient to hospital again. This causes costly re-hospitalizations that could be reduced by optimizing care of the patient throughout this cycle. An early adjustment of a service, for example an adjustment of the medication, may have avoided the re-hospitalization altogether.

To optimize care and to improve clinical outcomes there is a growing body of evidenced, that appropriate services need to be put in place at all stages of the care cycle, including the patient's home. For example, an educational service may help the patient to improve his self-care ability by increasing the patient's education through an education portal. A fall detector can help to detect when sudden events occur.

Further services assist a clinician to detect a deterioration of the patient's condition at an early stage, for example through patient monitoring using a weight scale, blood-pressure meter, or a fluid-accumulation vest. A fluid accumulation vest can help to identify thoracic fluid build-up at an early stage and appropriate countermeasures can be adopted. A ‘service’ as used herein encompasses measures and devices, all with associated hardware and software components.

Today, these services are assigned to the patient in an ad-hoc fashion and may be exclusive for one care setting. For example, a patient is assigned services at home by a home-health agency, which are not necessarily recommended or endorsed by a primary care setting, for example a treating physician at the hospital.

Furthermore, the services should be tailored to the patient's needs for a desired outcome. For example, the patient might be assigned a blood-pressure meter as part of generic advice given to all hypertension or heart-failure patients. The patient is told to measure the blood pressure every day and this requirement would unnecessarily continue even in the case where his blood pressure stabilizes and the risk of health deterioration due to this is significantly decreased. Thus, the service offering is not tailored to the current patient health status and needs.

As a further example, after a few months of using Philips Motiva educational videos, the patient's knowledge level has increased to a sufficient level. However, the confidence in the patient's own ability of doing physical activity may have decreased. In this case an educational service that is more active and provides a coaching component as well might be better for maintaining or improving the patient's health. This requires a self-adapting system.

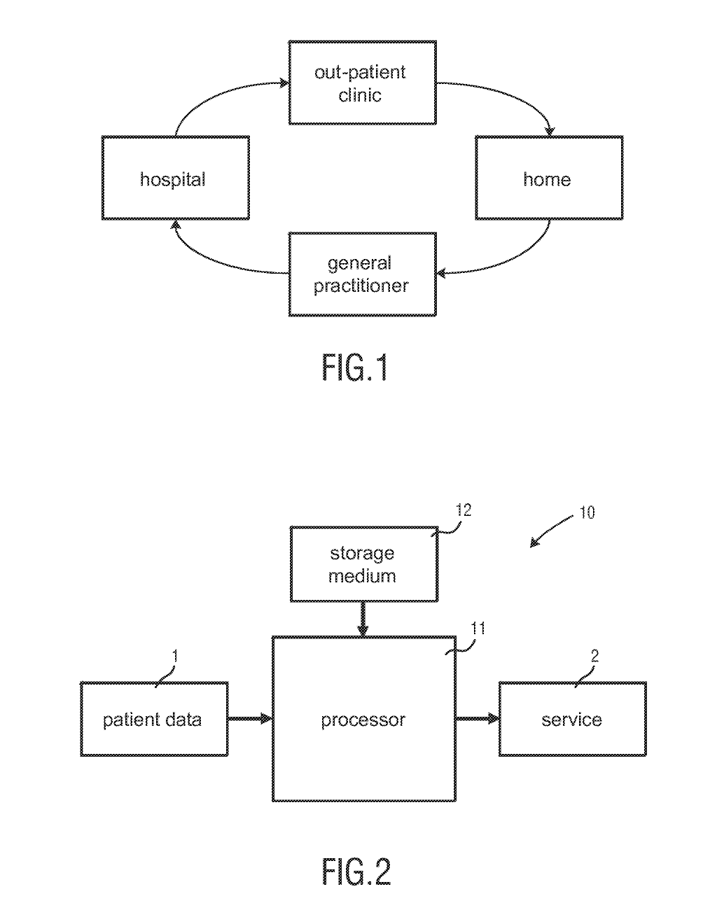

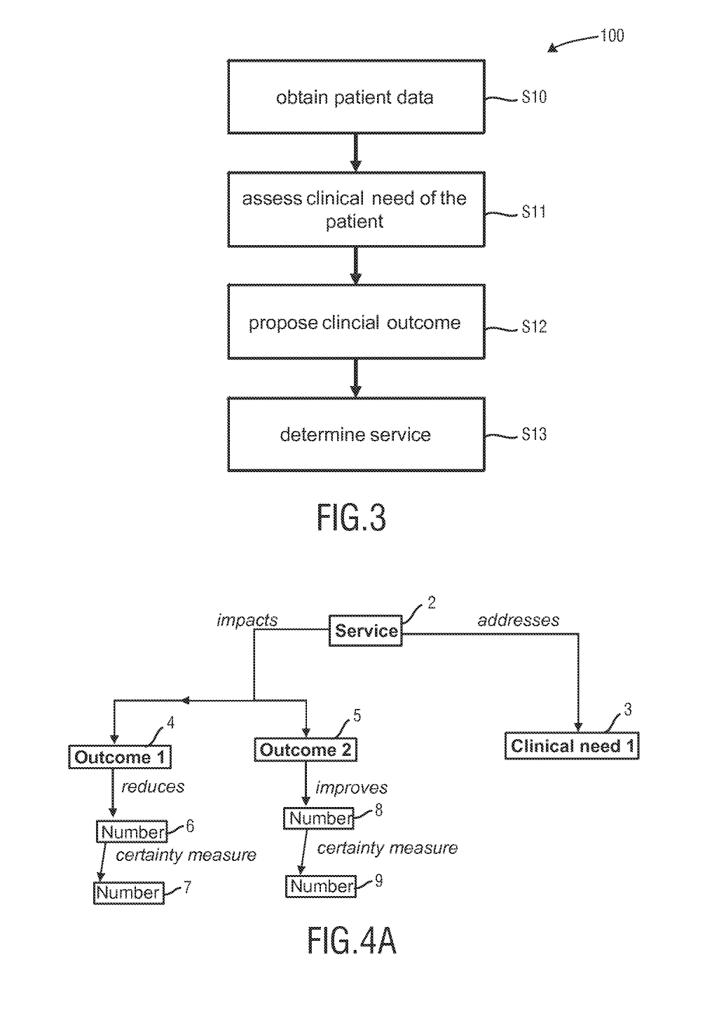

FIG. 2 shows a schematic diagram of a first embodiment of a healthcare support system 10 according to an aspect of the present invention. The system 10 comprises a processor 11 and a computer-readable storage medium 12. The computer-readable storage medium 12 contains instructions for execution by the processor 11. These instructions cause the processor 11 to perform the steps of a healthcare support method 100 as illustrated in the flow chart shown in FIG. 3.

In a first step S10 patient data 1 is obtained. In a second step S11 a clinical need of the patient is assessed. In a third step S12 a clinical outcome is proposed. This proposed clinical outcome can include a target care setting for the patient. For example, that the patient is discharged home or discharged to a nursing facility. In a fourth step, a service 2 to be provided to the patient is determined for said clinical need and said proposed clinical outcome based on the service-outcome-need model. The proposed healthcare support system not only considers the clinical need of the patient but also includes the proposed clinical outcome in the determination of the appropriate service.

For example, a broader variety of services may be available for a patient that is discharged to a nursing home compared to a patient that is discharged home for self-care. Thereby, the services can be optimized across care-settings. Knowing that a patient will be discharged home, a service can already be introduced in hospital so that the patient can get used to the service before relying on this service by himself at home. The proposed system and method helps caregivers to improve the care of chronic patients by providing them support to identify a number of services based on patient's specific needs and furthermore helps to calibrate these services across care setting and through natural progression of patients' condition and co-morbidities to ensure the best care for a particular patient.

An advantageous embodiment of the proposed healthcare support system comprises three main elements: A service-outcome-need model, a service database and a clinical needs ontology.

The service-outcome-need model gives a relationship between a particular service (for example a fluid-accumulation vest or education), a clinical outcome (for example readmission or self-care), and a clinical need it addresses (for example thoracic fluid build-up or knowledge).

The service database comprises an instance of the service-outcome-need model for each service. The model for each service can be obtained via a data analysis of a historical patient population. Furthermore patient classes are associated with each service. For example, an instance of the service-outcome-need model is set up for the service ‘fluid accumulation vest’. The service-outcome-need model describes that, for a particular class of patients, the service fluid accumulation vest positively affects readmissions by providing information about the thoracic volume.

A clinical needs ontology gives a relationship of the clinical needs for a particular clinical domain or disease. A clinical ontology indicates, for example, that weight changes could also adversely influence blood pressure.

The following will describe two steps for providing a basis for the healthcare support system. A first step comprises analyzing data for each of the services on a patient population level. A second step comprises analyzing a domain model to obtain a relevant ontology for the clinical needs. An example of a domain model is the combination of standardized medical knowledge, such as represented in SNOMED, and information in a same or similar format as defined for the local situation. These relations can be particular to the care offerings and quality standards of the local care system/hospital. Thus, the domain model can serve for adaption to one or more local care settings.

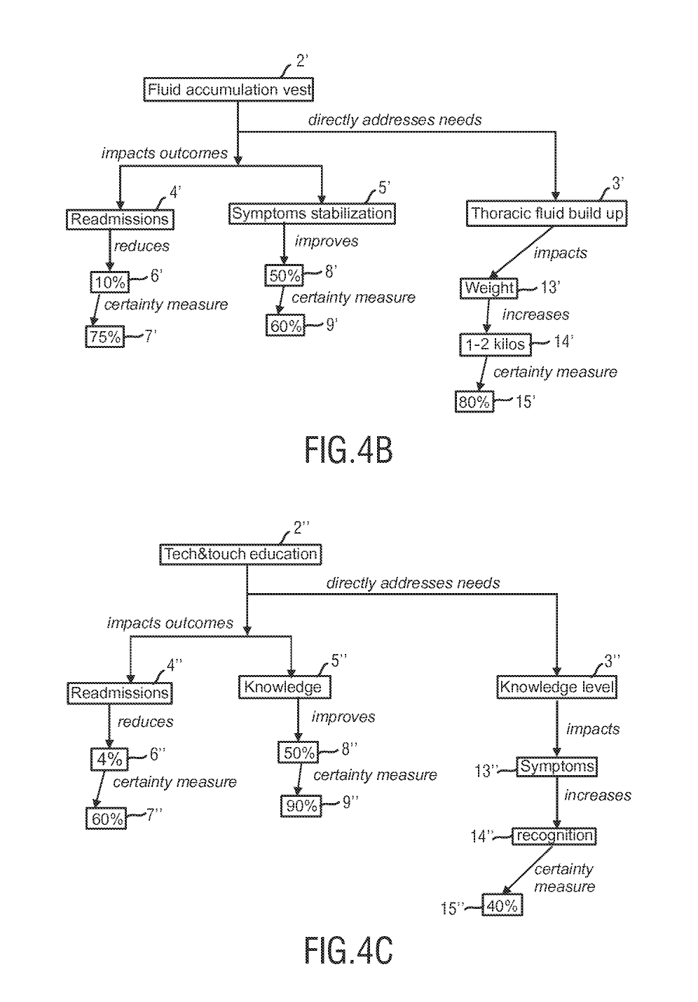

In a first aspect of the first step, a service database can be created based on patient population data. For each service, an instance of the service-outcome-need model is created. An example of how the service-outcome-need model could be represented is shown in FIG. 4A. The service 2 addresses a first clinical need 3. Furthermore, the service 2 impacts a first outcome 4 and a second outcome 5. In the shown example, the first outcome 4 reduces an item 6 with a certainty measure given by item 7. Correspondingly, the second outcome 5 improves an item 8 with a certainty measure given by item 9.

FIG. 4B shows an instance of the service-outcome-need model for the exemplary service ‘fluid accumulation vest’. For example, the patient has problems with thoracic fluid build-up 3′. The fluid accumulation vest 2′ directly addresses this clinical need. The thoracic fluid build-up 3′ impacts the weight 13′ of the patient. The weight 13′ increases about 1 to 2 kilos 14′ with the certainty of 80% 15′. The fluid accumulation vest 2′ as a service provided to the patient has impact on the readmissions 4′ as the first outcome and further impacts the symptoms stabilization 5′ as the second outcome. Readmissions 4′ in this example reduce by 10% 6′ with a certainty measure of 75% 7′. The symptoms stabilization 5′ as the second outcome improves by 50% 8′ with a certainty measure of 60% 9′.

FIG. 4C illustrates a further instance of the service-outcome-need model of FIG. 4A. This example relates to tech & touch education 2″ as the service 2. The tech & touch education 2″ directly addresses the clinical need ‘knowledge level’ 3″ of the patient which in turn impacts the symptoms 13″ by increasing the recognition 14″ with a certainty measure of 40% 15″. The tech & touch education 2″ impacts the outcome ‘readmissions’ 4″ as described with reference to the example given in FIG. 4B. Furthermore, the second outcome ‘knowledge’ 5″ improves by 50% 8′ with a certainty measure of 90% 9″. The knowledge of the patient can be assessed, for example, with a questionnaire.

Referring back to the service-data base, an instance for the service-outcome-need-model can be created as follows:

i. Collect data sources that are used in clinical studies and/or measurement data from a patient monitor or from a database including an electronic health record of a plurality of patients.

ii. Using data analysis techniques, mine the data to obtain the key outcomes that the service is able to influence. Thereby, a service-outcome model can be populated, where for each service and outcome there is an indication of the percentage a service increases or decreases an outcome and a certainty of the outcome, as illustrated in FIGS. 4A to 4C.

iii. This service-outcome model is enriched with the clinical needs addressed by the service, thereby creating the service-outcome-need model. According to an aspect of the invention, this enrichment of the service-outcome model with the clinical needs addressed by the service is not only based on data analysis of existing patient population data but is further based on clinical knowledge, in particular clinical knowledge from experts and clinical knowledge gathered from medical journals.

A second aspect of the first step relates to creating patient classes that correspond to certain services. Patient classes can for example be created via data analysis. For this purpose, historic patient data can be used. Patient data for each patient encompasses at least one of clinical characteristics (for example blood pressure, weight, fluid status), social and demographic parameters (for example social characteristics, admission details, medical history, length of stay in hospital), and parameters that describe a service-usage (for example number of days of usage after enrollment to a service, number of interactions with caregivers during service usage and other administrative data such as insurance details). However, patient data is not limited in this respect.

The creation of patient classes can further involve subdividing patients into groups, referred to as classes, where within a class patients respond similar to a service or set of services. Alternatively or in addition, there are differences in the response of patients of different classes to a service or set of services. The creation of classes can be performed by machine-learning techniques. For example, clustering can be performed fully unsupervised by machine-learning techniques. Alternatively, according to an aspect of the present invention, the classification is at least assisted by input from and/or validation by a clinical expert. The output is a grouping, i.e., a classification, of patients. Each class of patients can be characterized in terms of the parameters used to describe the patients, i.e. clinical parameters, social condition, administrative data and the like, for example by taking the mean or medium value from all patients in a group. Furthermore, an uncertainty of the classification can be given by statistic parameters such as the standard deviation.

Further to the subdivision of patients to classes, also the composite success rates of services per patient class can be calculated. Each service for the patient class can be associated with outcomes. Optionally, also the period of time the outcome is achieved and/or patient perceived satisfaction and/or compliance to usage of the service are determined Service-usage data of all patients in this patient class can be combined into a single measure for success for the service for patients in this class.

Furthermore, the composite patient characteristics of the patient class can be compared to general targets, which in turn can be compared to clinical outcomes of a given service. For example, the systolic blood pressure is known to have a proper value around 120 mm Hg, the class average might be 150 mm Hg and a coaching service for physical activity is able to reduce this value by 20%. From this information, one can conclude that this particular service is in principle able to successfully guide patients belonging to this patient class to healthy blood pressure values.

Alternatively, these two different types of success measures can be combined into a single measure, for example by taking a weighted average, which allows for the creation of an ordered list of services per patient class based upon their success rate.

FIG. 5 illustrates the collection of service-outcome-need models and patient classes into a common services database 20. For each service 21, 22, 23, the aforementioned instance of the service-outcome-need model 24 is created. Furthermore, a patient population from a patient-population database 25 is analyzed 26 to create a plurality of patient classes 27. These operations are also performed for the further services 22, 23. The results are collected in the services database 20. In the step of determining the service to be provided to the patient for the clinical need and the proposed clinical outcome, S13 in FIG. 3, this services database 20 can be accessed.

Referring now to the second step for providing a basis for the healthcare support system, a further aspect of the present disclosure relates to the creation of a domain model of the clinical needs. Based on the disease in question an ontology that relates clinical needs can be built. Advantageously, the ontology is built with input of at least one of a clinical professional or data from medical journals. Furthermore, also for comorbidities, such as diabetes and heart failure, an ontology may be used to model clinical needs. The domain model can encompass the selection of the right ontology or multiple ontologies or parts of ontologies that are of importance to the patient, given his disease and care setting, for example home or hospital.

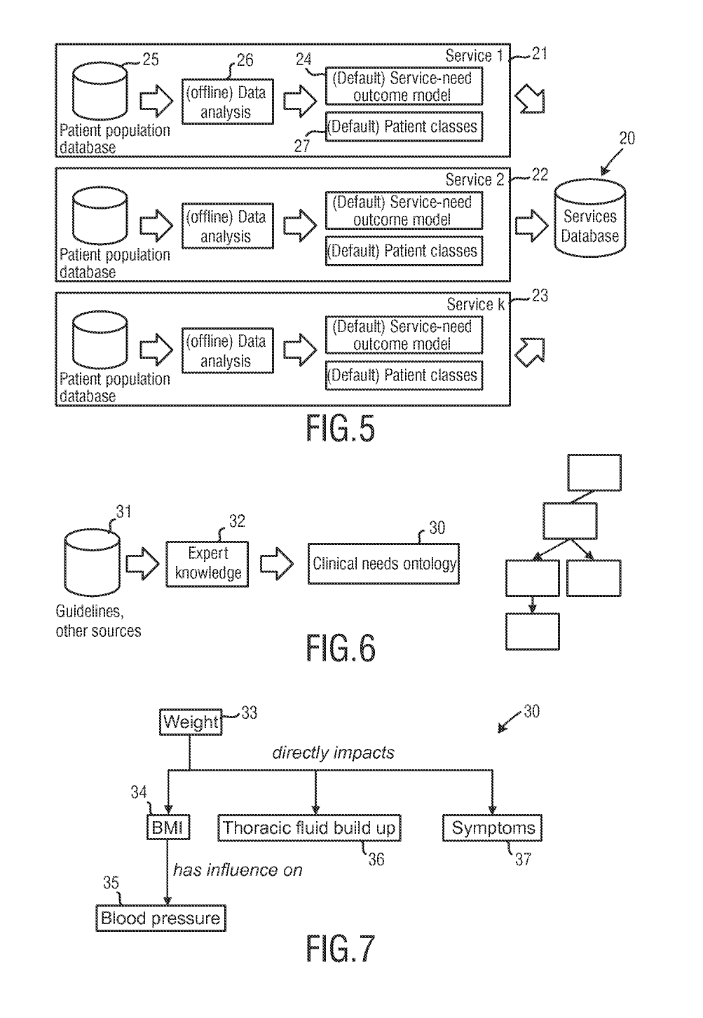

FIG. 6 illustrates the creation of a clinical needs ontology 30. Based on guidelines and other sources 31, in particular structured sources like medical journals, and expert knowledge 32 the clinical needs ontology 30 is established which then relates clinical needs to one another. Alternatively, the sequence of elements 31 and 32 is changed or they are used in parallel.

FIG. 7 illustrates an example of a clinical-needs ontology 30 that gives a relationship of clinical needs for a heart-failure patient. In this example, the clinical-need weight 33 directly impacts the clinical needs body mass index (BMI) 34 which in turn has an influence on the clinical need blood pressure 35. Furthermore, the weight 33 directly impacts thoracic fluid built-up 36 and further symptoms 37. A clinical needs ontology 30 is not limited in this respect but could also be a mesh-like structure with multiple dependencies.

The use of ontologies in addition to purely relying on existing patient population data is particularly advantageous in cases where no data is available that would reveal relations between outcomes and services. For example a service can be new to the world or new to the hospital. For such cases, it is beneficial to use additional knowledge sources such as ontologies that provide or at least help to derive the connection between outcome and service.

Advantageously, a combination of three strategies is used to infer an anticipated outcome for a given service. Firstly, patient-population data can be analyzed by applying data mining techniques. The patient population can be local, regional, country-wide or even global. Secondly, information from structured sources, such as an ontology, can be used that describe patient characteristics, service interventions and outcomes. Thirdly, evidence extracted from medical journals can be used, where patient characteristics, service interventions and outcomes are extracted using natural language processing techniques. If there is conflicting evidence between any of these sources, a hierarchy can be established. Local evidence, i.e. evidence from a patient population, in particular a local patient population prevails over broader evidence using structured sources. Furthermore, evidence gained using patient population data prevails over evidence from structured sources, which in turn prevails over evidence extracted from medical journals.

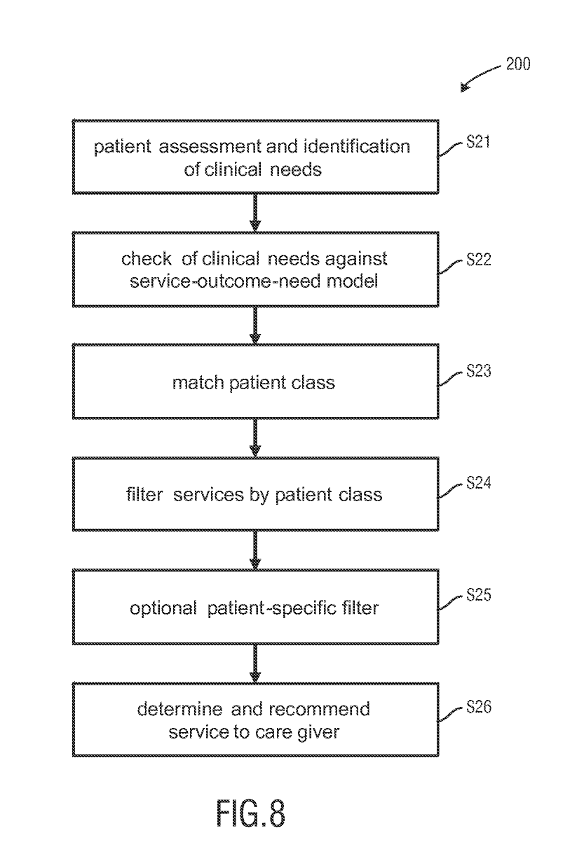

FIG. 8 illustrates a further embodiment of the present disclosure. When the patient is first hospitalized and/or diagnosed the initial service determination or matching for the patient can comprise the following steps shown in the flow chart 200.

In a first step S21, a caregiver assesses the patient in a traditional fashion and thereby identifies clinical needs of the patient. This step can be further assisted by the healthcare support system which obtains patient data of the current patient and assesses a clinical need of the patient based upon patient data and input from a caregiver or a patient himself.

In a second step S22, these clinical needs are checked against instances of the service-outcome-need model top to bottom, and thereby identify which services would fulfill the clinical needs of the patient. Instances of the service-outcome-need model are provided by the services database.

In step S23, the obtained patient data which includes patient characteristics, is used to find the best matching patient class. For example, this matching can be based upon a distance or dissimilarity measure to compare the patient characteristics with the characteristics of the patient classes.

In step S24, the ordered list of services for the selected patient class is taken and filtered for services that have been identified in step S22. Step S24 thereby provides an ordered list of services that could be suitable for this patient. For example, the best service is the one on top.

An optional patient-specific filter is applied in step S25. Under the condition that historic information on services that have previously been used by this particular patient is available, the ordered list can be further filtered, for example, by filtering out service that did not work or did not have the desired impact on this particular patient. A further or alternative additional filter could filter out services that would be over budget, taking into account the financial situation and insurance of the patient, or services that are simply not available across different care settings. For example, instead of selecting a service that is special for the current care facility, an alternative service can be preferred that is available throughout the entire care cycle.

In the last step S26, the determined services to be provided to the patient are recommended to the caregiver to provide to the patient.

For example, the patient's key needs are to stabilize the thoracic volume overload and to increase his knowledge. In this case, the fluid accumulation vest and the tech & touch educational DVD could be recommended to the caregiver to offer to the patient. If it turns out that this patient fits well into a patient class for which the fluid accumulation vest generally has more effect, i.e., a higher success rate in addressing the volume overload need, the service ‘fluid accumulation vest’ can be determined as the best matching service to be provided. For a different patient, the tech & touch educational DVD could be the preferred choice.

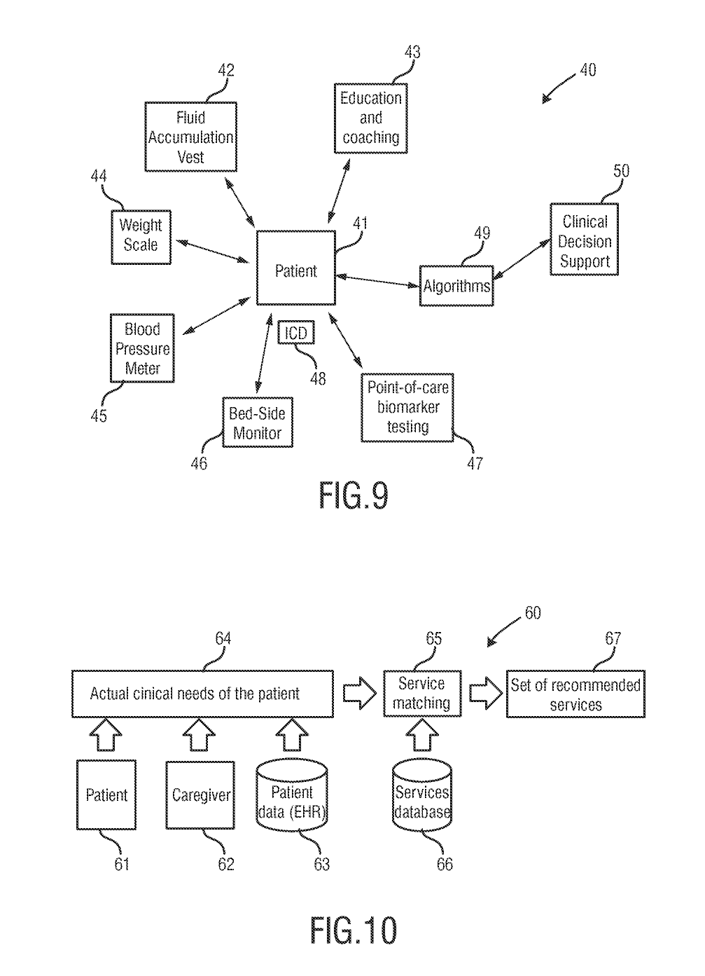

When the patient is at home, he will use the determined services. FIG. 9 shows an example of a set of services 40 that are provided to the patient 41. In this example, the set of services 40 comprises a fluid accumulation vest 42, education and coaching material 43, a weight scale 44, a blood-pressure meter 45, a bedside monitor 46 and a point of care biomarker testing device 47 as well as an implantable cardioverter-defibrilator (ICD) 48. Measurement data from one or more of these devices can be available for analysis using an automated program with algorithms 49 and can also form the basis for further clinical decision support 50. For the case of educational material, knowledge of the patient can be measured by the quality of his answers.

FIG. 10 further illustrates the process 60 of determining services to be provided to the patient for the example of a newly diagnosed patient. In this example, patient data is obtained by input from the patient 61, an examination by the caregiver 62 and using patient data 63 obtained from an electronic health record (EHR). Based on this information, the healthcare support system assesses the actual clinical needs of the patient 64. The service matching 65 comprises the steps of proposing a clinical outcome, for example lowering the blood pressure, such that the patient can be discharged from hospital for self-care at home and determining the corresponding service to be provided to the patient for said clinical need and said proposed clinical outcome based on the service-outcome-need model. For this purpose, the service matching 65 has access to the services database 66. The output of this process is a set of recommended services. These services determined by the healthcare support system can be provided as recommendations to the caregiver 62 and the patient 61.

In clinical practice, specialist physicians and nurses often have a limited scope on the patient and corresponding treatment responsibilities. They can be focused on their field of expertise. For example, a senior cardiologist will mainly worry about pharmaceutical treatment of the patient's heart condition and leave the treatment of co-morbidities to his colleague specialist (e.g. the rheumatologist, a COPD expert etc.). Nursing staff is skilled in the selection of services specific to their particular medical specialism. The disclosed healthcare support system and method will help such nurses, the intended main user, to draft an evidence-based care plan beyond their specialism.

Optionally, the clinical needs of the patient can be re-assessed and the services re-calibrated on a recurring, for example daily basis. For example, if the patient knowledge has increased to the level that satisfies the outcomes, then the system could recommend to the caregiver to remove the service from the patient's home or to otherwise discontinue the service. Thereby, superfluous services can be eliminated and a treatment cost can be reduced.

Furthermore, if this healthcare support system learns and gains new insights in the success of services that address the needs of a patient, and finds out that the patient would benefit more from a different service other than the one he currently uses, the system could provide a recommendation to the caregiver to change the service for this patient.

Moreover, based on the clinical needs ontology, the system can do the matching between the current patient clinical needs and the potential needs that might be impacted in view of the given assessment of the current needs. For example, if the ontology gives a direct relationship between the weight and further symptoms, then the symptoms are the potential need that might be impacted and the system would use that information to match it with patient data on the symptoms or suggest to the caregiver to re-assess the symptoms in the next visit in order to re-adjust the services for the best outcome.

In general, this invention is applicable to any clinical domain in which patients need to be followed across healthcare settings. The automated assignment of services to patients is of particular relevance to home-health solutions. Furthermore, in-hospital solutions of cardiology informatics such as the Intellispace Cardiovascular of the applicant can also benefit from this invention by incorporating the determination of a service into their clinical module features.

In conclusion, the elements of the present disclosure help to identify the most appropriate services for the patient based on his health status and desired outcomes and to automatically, based on the current patient health status, suggest adjustments of the services from the service database.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible device or apparatus that can contain, store, communicate, propagate, or transport the program for use by or in connection with the instruction execution device.

In so far as embodiments of the disclosure have been described as being implemented, at least in part, by software-controlled data processing devices, it will be appreciated that the non-transitory machine-readable medium carrying such software, such as an optical disk, a magnetic disk, semiconductor memory or the like, is also considered to represent an embodiment of the present disclosure.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example, without limitation, physical or wireless.

A data processing system or device suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories, which provide temporary storage of at least some computer readable or computer usable program code to reduce the number of times code may be retrieved from bulk storage during execution of the code.

Input/output, or I/O devices, can be coupled to the system either directly or through intervening I/O controllers. These devices may include, for example, without limitation, keyboards, touch screen displays, and pointing devices. Different communications adapters may also be coupled to the system to enable the data processing system to become coupled to other data processing systems, remote printers, or storage devices through intervening private or public networks. Non-limiting examples are modems and network adapters and are just a few of the currently available types of communications adapters.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated. Other variations to the disclosed embodiments can be understood and effected by those skilled in the art in practicing the claimed invention, from a study of the drawings, the disclosure, and the appended claims.

1. A healthcare support system for determining care for a patient, the system comprising a processor and a computer-readable storage medium, wherein the computer-readable storage medium contains instructions for execution by the processor, wherein the instructions cause the processor to perform the steps of:
obtaining patient data,
assessing a clinical need of the patient,
proposing a clinical outcome, and
determining a service to be provided to the patient for said clinical need and said proposed clinical outcome based on a service-outcome-need model.

2. The healthcare support system as claimed in claim 1,
wherein the service-outcome-need model provides a relationship between a service provided to the patient, a clinical outcome and a clinical need of the patient.

3. The healthcare support system as claimed in claim 1,
wherein the service-outcome-need model further comprises an ontology, which ontology gives a relationship of clinical needs for a clinical domain or a disease.

4. The healthcare support system as claimed in claim 1,
further comprising a service database wherein for each service there is an instance of the service-outcome-need model.

5. The healthcare support system as claimed in claim 4,
wherein the instructions further cause the processor to perform the step of creating said service database based on patient data.

6. The healthcare support system as claimed in claim 5,
wherein said creation of said service database further comprises obtaining data from clinical studies and/or clinical experts.

7. The healthcare support system as claimed in claim 4,
wherein the instructions further cause the processor to perform the step of updating said service database based on the obtained data.

8. The healthcare support system as claimed in claim 1,
wherein said healthcare support system is a self-adapting system.

9. The healthcare support system as claimed in claim 8,
wherein the service to be provided to the patient is determined when new patient data is obtained and/or when the service-outcome-need model is updated.

10. The healthcare support system as claimed in claim 1,
wherein the service-outcome-need model comprises patient classes.

11. The healthcare support system as claimed in claim 10,
wherein patient class data associated with said patient classes is based on patient data from a historical patient population.

12. A healthcare support method for determining care for a patient comprising the steps of:
obtaining patient data,
assessing a clinical need of the patient,
proposing a clinical outcome, and
determining a service to be provided to the patient for said clinical need and said proposed clinical outcome based on a service-outcome-need model.

13. A computer-readable non-transitory storage medium containing instructions for execution by a processor, wherein the instructions cause the processor to perform the steps of the method as claimed in claim 12.

14. Computer program comprising program code means for causing a computer to carry out the steps of the method as claimed in claim 12 when said computer program is carried out on the computer.

15. A healthcare support system for determining care for a patient comprising:
means for obtaining patient data,
means for assessing a clinical need of the patient,
means for proposing a clinical outcome, and
means for determining a service to be provided to the patient for said clinical need and said proposed clinical outcome based on a service-outcome-need model.
